(19) United States
(12) Patent Application Publication
(10) Pub. No.: US 2023/0229740 A1
(43) Pub. Date: Jul. 20, 2023

(54) MULTICLASS CLASSIFICATION APPARATUS AND METHOD ROBUST TO IMBALANCED DATA

(71) Applicant: Electronics and Telecommunications Research Institute, Daejeon (KR)

(72) Inventors: MINHO PARK, Daejeon (KR); Dong-oh KANG, Daejeon (KR); Hwajeon SONG, Daejeon (KR); Jeun Woo LEE, Daejeon (KR)

(73) Assignee: Electronics and Telecommunications Research Institute, Daejeon (KR)

(21) Appl. No.: 18/070,979

(22) Filed: Nov. 29, 2022

(30) Foreign Application Priority Data
Jan. 17, 2022 (KR) 10-2022-0006655

(51) Int. Cl. G06F 18/2431; G06F 18/28

(52) U.S. Cl. CPC G06F 18/2431; G06F 18/28

(57) ABSTRACT

The present invention provides a multiclass classification apparatus and method robust to imbalanced data, which generate artificial data of a minority class on the basis of an over-sampling technique based on adversarial learning to balance imbalanced data and performs multiclass classification robust to imbalanced data by using corresponding data in class classification learning without additionally collecting data.

### CROSS-REFERENCE TO RELATED APPLICATIONS

This application claims the benefit of the Korean Patent Application No. 10-2022-0006655 filed on Jan. 17, 2022, which is hereby incorporated by reference as if fully set forth herein.

### BACKGROUND

### Field of the Invention

The present invention relates to a multiclass classification apparatus and method, and more particularly, to a multiclass classification apparatus and method robust to imbalanced data.

### Discussion of the Related Art

Multiclass classification technology of the related art is performed through a preprocessing process, a feature extraction process, and a class classification process. In order to effectively learn a class classification framework, only when various features of each class of data are extracted in a feature extraction process in a pipeline, it is easy to understand and classify a corresponding class. However, in terms of a characteristic of real-life data, because the consumption of time and cost is too large to collecting a sufficient amount of data between classes, it is difficult to build a balanced data set. Class classification technologies, which do not consider an unbalanced problem between classes of learning data of the related art, have a problem where a minority class is low in performance and is overfitting.

General image classification technologies of the related art include data re-sampling technology which artificially manipulates pieces of data of each class to treat a problem of unbalanced class classification. There are technologies which balancedly readjust the number of data of each class by decreasing (under-sampling) the number of data of a majority class or artificially generating (over-sampling) data of a minority class. However, such technologies of the related art do not consider characteristics of multiclass classification and extracted features, and due to this, are difficult to be directly applied.

### SUMMARY

An aspect of the present invention is directed to providing a multiclass classification apparatus and method robust to imbalanced data, which generate artificial data of a minority class on the basis of an over-sampling technique based on adversarial learning to balance imbalanced data and performs multiclass classification robust to imbalanced data by using corresponding data in class classification learning without additionally collecting data.

To achieve these and other advantages and in accordance with the purpose of the invention, as embodied and broadly described herein, there is provided a multiclass classification apparatus robust to imbalanced data, the multiclass classification apparatus including a balanced learning data configuration unit configured to receive imbalanced learning data to obtain balanced learning data and a model learning unit configured to receive the balanced learning data from the balanced learning data configuration unit to provide a class result predicted through model learning.

In an embodiment, the balanced learning data configuration unit may include a feature extraction unit configured to extract a feature of the imbalanced learning data, a feature dictionary unit configured to randomly sample some of feature maps obtained from the feature extraction unit to generate a feature dictionary, and a feature generating unit configured to generate artificial data, based on a convex combination of a convex weight and the feature dictionary.

In an embodiment, the feature generating unit may include a generator configured to receive noise and a fake class and a convex weighting unit configured to output the convex weight by using softmax.

In an embodiment, the feature generating unit may complement a minority class with the artificial data.

In an embodiment, the feature generating unit may perform adversarial training which allows artificial data to be similar to a distribution of real data.

In an embodiment, the feature extraction unit may include a feature extractor configured to extract the feature and a feature adaptation unit configured to allow the feature to obtain one characteristic of a shape, an edge, and a color of an image, and the obtained features may be integrated as one.

In an embodiment, the model learning unit may include a tuning feature extraction unit configured to finely tune a feature extraction method of the feature extraction unit, based on the balanced learning data and a multiclass classification unit configured to classify a class into a plurality of classes by using the feature extracted from the tuning feature extraction unit.

In another aspect of the present invention, there is provided a multiclass classification method robust to imbalanced data, the multiclass classification method including a balanced learning data configuration step of receiving imbalanced learning data to obtain balanced learning data by using a balanced learning data configuration unit and a model learning step of receiving the balanced learning data from the balanced learning data configuration unit to provide a class result predicted through model learning by using a model learning unit.

In an embodiment, the balanced learning data configuration step may include a feature extraction step of extracting a feature of the imbalanced learning data by using a feature extraction unit, a feature dictionary generating step of randomly sampling some of feature maps obtained from the feature extraction unit to generate a feature dictionary by using a feature dictionary unit, and a feature generating step of generating artificial data by using a feature generating unit, based on a convex combination of a convex weight and the feature dictionary.

In an embodiment, the feature generating step may include a generating step of receiving noise and a fake class by using a generator and a convex weighting unit configured to output the convex weight by using a convex weighting unit, based on softmax.

In an embodiment, the feature generating step may include a step of complementing a minority class with the artificial data.

In an embodiment, the feature generating step may include a step of performing adversarial training which allows artificial data to be similar to a distribution of real data.

In an embodiment, the feature extraction step may include a feature extraction step of extracting the feature by using a feature extractor and a feature adaptation step of allowing the feature to obtain one characteristic of a shape, an edge, and a color of an image by using a feature adaptation unit, and the obtained features may be integrated as one.

In an embodiment, the model learning step may include a tuning feature extraction step of finely tuning a feature extraction method of the feature extraction unit by using a tuning feature extraction unit, based on the balanced learning data and a multiclass classification step of classifying a class into a plurality of classes by using a multiclass classification unit, based on the feature extracted from the tuning feature extraction unit.

In another aspect of the present invention, there is provided a feature generator used in a multiclass classification apparatus robust to imbalanced data, the feature generator including a generator configured to receive noise and a fake class, a convex weighting unit configured to output a convex weight by using softmax, an artificial data generating unit configured to generate artificial data, based on a convex combination of the convex weight output from the convex weighting unit and a previously generated feature dictionary, and an adversarial training unit configured to perform adversarial training which allows the artificial data to be similar to a distribution of real data.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram for describing a multiclass classification apparatus robust to imbalanced data according to an embodiment of the present invention.

FIG. 2 is a diagram for describing a balanced learning data configuration unit according to an embodiment of the present invention.

FIG. 3 is a diagram for describing a model learning unit according to an embodiment of the present invention.

FIG. 4 is a diagram for describing a feature extraction unit according to an embodiment of the present invention.

FIG. 5 is a diagram for describing a feature generating unit according to an embodiment of the present invention.

FIG. 6 is a diagram for describing adversarial training according to an embodiment of the present invention.

FIG. 7 is a flowchart for describing a multiclass classification method robust to imbalanced data according to an embodiment of the present invention.

FIG. 8 is a flowchart for describing a balanced learning data configuration method and a model learning method according to an embodiment of the present invention.

FIG. 9 is a block diagram illustrating a computer system for implementing a method according to an embodiment of the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

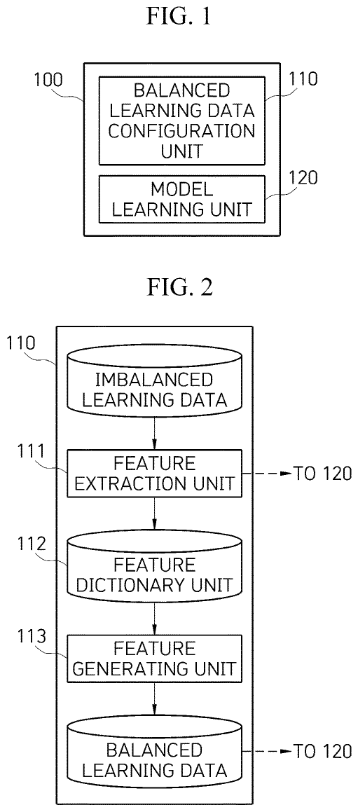

Hereinafter, a multiclass classification apparatus and method robust to imbalanced data according to various embodiments of the present invention will be described in detail with reference to FIGS. 1 to 8.

FIG. 1 is a diagram for describing a multiclass classification apparatus 100 robust to imbalanced data according to an embodiment of the present invention.

Referring to FIG. 1, the multiclass classification apparatus 100 robust to imbalanced data may include a balanced learning data configuration unit 110 and a model learning unit 120.

The balanced learning data configuration unit 110 may receive imbalanced learning data to obtain balanced learning data.

The model learning unit 120 may receive the balanced learning data from the balanced learning data configuration unit 110 to provide a class result predicted through model learning.

In other words, the balanced learning data configuration unit 110 may generate balanced data by using a feature generating unit based on a feature dictionary, and the model learning unit 120 may train a class classifier and a feature extraction unit which tunes the balanced learning data.

In more detail, the balanced learning data configuration unit 110 may include a feature extraction unit 111, a feature dictionary unit 112, and a feature generating unit 113.

The feature extraction unit 111 may extract a feature of the imbalanced learning data and may be configured based on a backbone network which is widely used to extract a feature of a computer vision image based on deep learning. This may be repeatedly performed on all of imbalanced data.

Moreover, the feature extraction unit 111 may include a plurality of feature extractors which extract features and a feature adaptation unit which allow the extracted features to have one characteristic of a shape, an edge, and a color of an image.

Moreover, pieces of data where characteristics are obtained through a feature adaptation unit of the feature extraction unit 111 may be integrated as one.

The feature dictionary unit 112 may randomly sample some of feature maps obtained from the feature extraction unit 111 and may generate a feature dictionary through over-sampling. In this case, the number of feature maps to be sampled may be a hyper-parameter and may be heuristically corrected and used based on a data characteristic.

The feature generating unit 113 may include a generator which receives noise and a fake class and a convex weighting unit which outputs a convex weight by using softmax. The feature generating unit 113 may generate artificial data through a convex combination of the feature dictionary and the convex weight.

Moreover, the feature generating unit 113 may add the generated artificial data to a minority class to complement data of the minority class which is insufficient compared to a majority class, based on the artificial data.

Moreover, the feature generating unit 113 may perform adversarial training so that the artificial data is similar to a distribution of real data.

The model learning unit 120 may include a tuning feature extraction unit 121 which finely tunes a feature extraction method of the feature extraction unit on the basis of balanced learning data and a multiclass classification unit 122 which classifies a class into a plurality of classes by using a feature extracted from the tuning feature extraction unit 121.

FIG. 2 is a diagram for describing the balanced learning data configuration unit 110 according to an embodiment of the present invention.

Referring to FIG. 2, the balanced learning data configuration unit 110 may include a feature extraction unit 111, a feature dictionary unit 112, and a feature generating unit 113.

The feature extraction unit 111 may include a plurality of feature extractors and a feature adaptation unit. The feature extractor may use a backbone network which is commonly used in a case which extracts a feature in a deep learning-based computer vision field and may use a parameter which is pre-learned through an ImageNet data set.

Moreover, the feature adaptation unit may be a module which allows features obtained through the feature extractor to have a characteristic of an image, and thus, features concentrating on a shape, an edge, or a color of an object may be obtained. Here, the obtained features may be integrated as one through a concatenation process.

The feature extraction unit 111 may repeatedly perform the method on all of balanced data to obtain a feature map.

The feature dictionary unit 112 may randomly sample the feature map obtained from the feature extraction unit 111 and may generate a feature dictionary through over-sampling. In this case, the number of feature maps to be sampled may be a hyper-parameter and may be heuristically corrected and used based on a data characteristic.

The feature generating unit 113 may artificially generate minority class data where the number of pieces of data is relatively insufficient. In this case, a data number ratio between pieces of data may be assigned to be prior knowledge, and thus, more artificial data may be generated despite a class where the number of pieces of data is small.

The feature generating unit 113 may include a generator which receives random noise and a fake class to be generated and a convex weighting unit which outputs a convex weight on the basis of softmax by using the convex weighting unit. Therefore, artificial data may be generated by a convex combination based on a previously-generated feature dictionary. A minority class may be added to the fake class transferred as an input of the generator, and thus, data of an insufficient minority class may be complemented with artificial data.

Moreover, the feature generating unit 113 may perform adversarial training so that the artificial data is similar to a distribution of real data.

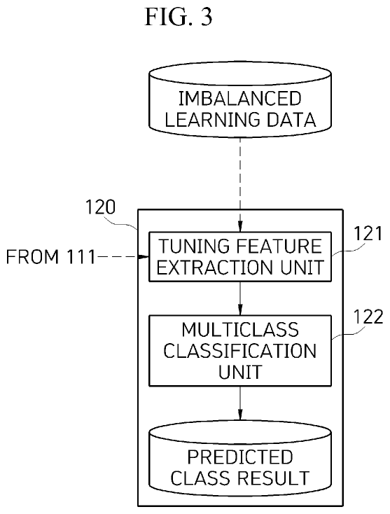

FIG. 3 is a diagram for describing the model learning unit 120 according to an embodiment of the present invention.

Referring to FIG. 3, the model learning unit 120 may include a tuning feature extraction unit 121 and a multiclass classification unit 122.

The tuning feature extraction unit 121 may finely tune a feature extraction method of the feature extraction unit 111, based on balanced learning data.

The classification performance of a minority class of data through a model fine tuning process.

The multiclass classification unit 122 may classify a class into a plurality of classes by using a feature extracted from the tuning feature extraction unit 121.

Accordingly, the multiclass classification unit 122 may perform balanced learning between classes, and thus, a multiclass classification model robust to balanced data may be obtained.

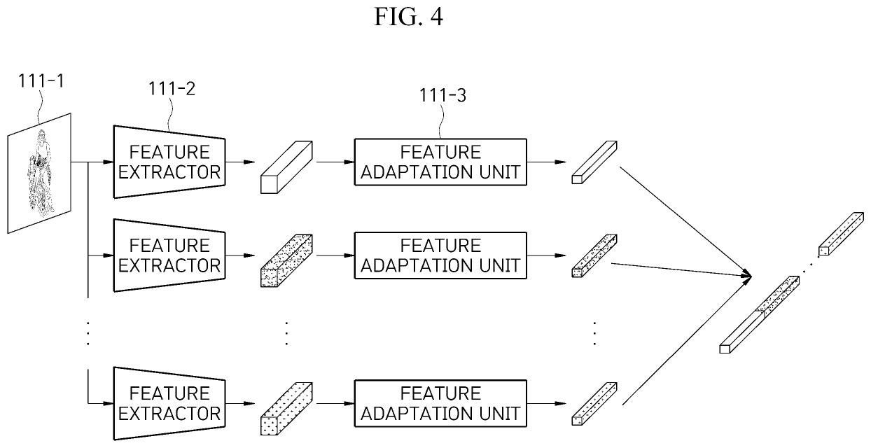

FIG. 4 is a diagram for describing the feature extraction unit 111 according to an embodiment of the present invention.

Referring to FIG. 4, the feature extraction unit 111 may include a feature extractor 111-2 and a feature adaptation unit 111-3.

The feature extractor 111-2 may use a backbone network which is commonly used in a case which extracts a feature in a deep learning-based computer vision field and may use a parameter which is pre-learned through an ImageNet data set.

Moreover, the feature adaptation unit 111-3 may be a module which allows features obtained through the feature extractor 111-2 to have a characteristic of an image, and thus, features concentrating on a shape, an edge, or a color of an object may be obtained. Here, the obtained features may be integrated as one through a concatenation process.

The feature extraction unit 111 may repeatedly perform the method on all of balanced data to obtain a feature map.

The feature extraction unit 111 may receive imbalanced learning data 111-1 to extract a feature of the balanced learning data 111-1 from the feature extractor 111-2 and may allow a concentration feature of each of features extracted through the feature adaptation unit 111-2 to be obtained.

Here, features may be integrated as one through a concatenation process.

Moreover, the feature extraction unit 111 may repeatedly perform the method on all of imbalanced data and may transfer integrated imbalanced learning data 111-1 to the feature dictionary unit 112.

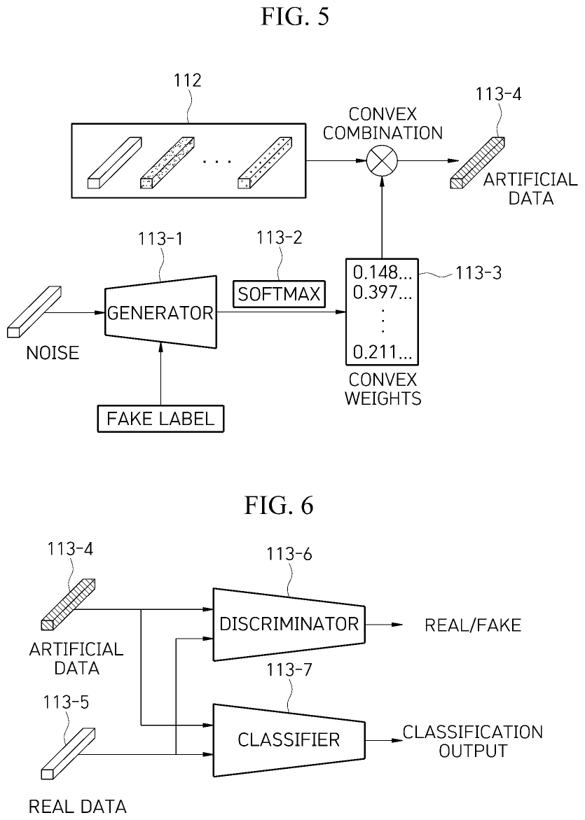

FIG. 5 is a diagram for describing the feature generating unit 113 according to an embodiment of the present invention.

Referring to FIG. 5, the feature generating unit 113 may include a generator 113-1 which receives random noise and a fake class to be generated and may output a convex weight on the basis of softmax 113-2 by using the convex weighting unit 113-3. Therefore, artificial data 113-4 may be generated by a convex combination based on a feature dictionary previously generated by the feature dictionary unit 112. A minority class may be added to the fake class transferred as an input of the generator 113-1, and thus, data of an insufficient minority class may be complemented with artificial data.

Moreover, the feature generating unit 113 may perform adversarial training so that the artificial data is similar to a distribution of real data.

FIG. 6 is a diagram for describing adversarial training according to an embodiment of the present invention.

First, adversarial training may be a learning method which is commonly used in learning of a generative model and may be a method where a generator and a discriminator are trained in adversarial directions.

Referring to FIG. 6, in the present invention, a class classifier 113-7 as well as a generator (not shown) and the discriminator 113-6 may perform learning including adversarial training, and thus, the artificial data 113-4 may be similar to a distribution of real data 113-5. The generator (not shown) may generate artificial data so that the discriminator 113-6 determines the real data 113-5 and the classifier 113-7 has a distribution difficult to classify. The discriminator 113-6 may determine the artificial data 113-4 as generated fake data, and the classifier 113-7 may be learned so that the artificial data 113-4 is normally classified.

In this manner, the generator (not shown) may generate the artificial data 113-4 based on a distribution of the real data. A feature generating unit including the generator (not shown) which has ended learning may generate imbalanced data to balanced data.

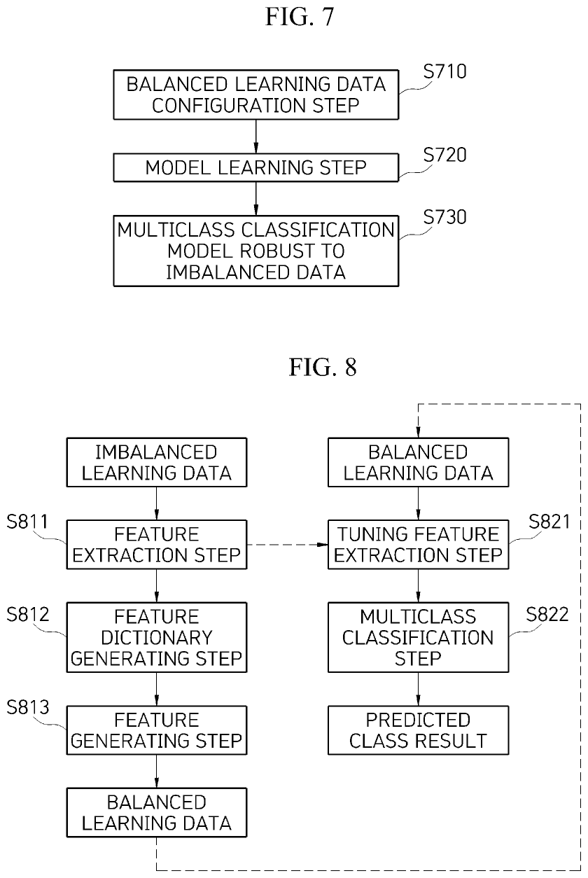

FIG. 7 is a flowchart for describing a multiclass classification method robust to imbalanced data according to an embodiment of the present invention.

Referring to FIG. 7, the multiclass classification method robust to imbalanced data may be performed by a balanced learning data configuration unit and may receive imbalanced learning data to obtain balanced learning data in step S710. Also, the multiclass classification method may receive the balanced learning data obtained from the balanced learning data configuration unit and may provide a class result predicted through model learning by a model learning unit in step S720, and thus, may obtain a multiclass classification model robust to imbalanced data in step S730.

FIG. 8 is a flowchart for describing a balanced learning data configuration method and a model learning method according to an embodiment of the present invention.

Referring to FIG. 8, the multiclass classification method robust to imbalanced data may include a balanced learning data configuration step and a model learning step.

The balanced learning data configuration step may receive imbalanced learning data and may extract a feature in step S811. Subsequently, a feature dictionary based on a feature may be generated by extracting a feature in step S812. Balanced learning data may be obtained by generating a feature where minority class data where the number of pieces of data is relatively insufficient is generated by using the feature dictionary in step S813.

The model learning unit may receive the obtained balanced learning data and may tune extraction of a feature, and thus, may enhance the classification performance of a minority class of data through a model fine tuning process in step S821.

Subsequently, the multiclass classification unit may classify a class into a plurality of classes by using a feature extracted from the tuning feature extraction unit in step S822 and may provide the predicted class result to obtain a multiclass classification model robust to imbalanced data.

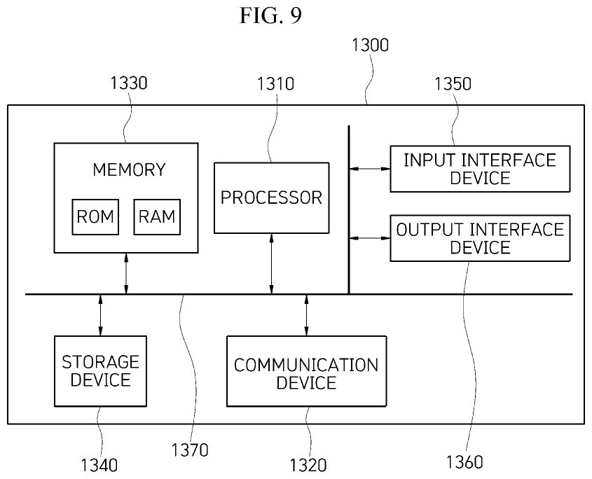

FIG. 9 is a block diagram illustrating a computer system 1300 for implementing a method according to an embodiment of the present invention.

Referring to FIG. 9, the computer system 1300 may be an apparatus for implementing a multiclass classification method robust to imbalanced data, a balanced learning data configuration method, and a model learning method.

To this end, the computer system 1300 may include at least one of a processor 1310, a memory 1330, an input interface device 1350, an output interface device 1360, and a storage device 1340 which communicate with one another through a bus 1380. The computer system 1300 may include a communication device 1320 connected to a network. The processor 1310 may be a central processing unit (CPU), or may be a semiconductor device which executes an instruction stored in the memory 1330 or the storage device 1340. The memory 1330 and the storage device 1340 may include various types of volatile or non-volatile storage mediums. For example, the memory 1330 may include read only memory (ROM) and random access memory (RAM). In an embodiment of the present invention, the memory 1330 may be provided in or outside the processor and may be connected to the processor through various means known to those skilled in the art. The memory may be various types of volatile or non-volatile storage mediums, and for example, may include ROM or RAM.

Therefore, an embodiment of the present invention may be a method implemented in a computer, or may be implemented as a non-transitory computer-readable medium storing a computer-executable instruction. In an embodiment, when executed by the processor, the computer-readable instruction may perform a method according at least one aspect of the present invention.

The communication device 1320 may transmit or receive a wired signal or a wireless signal.

Moreover, the method according to an embodiment of the present invention may be implemented as a program instruction type capable of being performed by various computer means and may be stored in a computer-readable recording medium.

The computer-readable recording medium may include a program instruction, a data file, or a data structure, or a combination thereof. The program instruction recorded in the computer-readable recording medium may be specially designed for an embodiment of the present invention, or may be known to those skilled in the computer software art and may be used. The computer-readable recording medium may store may include a hardware device which stores and executes the program instruction. For example, the computer-readable recording medium may be a magnetic media such as a hard disk, a floppy disk, and a magnetic tape, an optical media such as CD-ROM or DVD, a magneto-optical media such as a floptical disk, ROM, RAM, or flash memory. The program instruction may include a high-level language code executable by a computer such as an interpreter, in addition to a machine language code such as being generated by a compiler.

According to the embodiments of the present invention, a problem, where performance of multiclass classification is reduced due to data unbalance between classes, of common problems of several data used in the real world may be solved by complementing artificial data similar to real data through adversarial learning.

Moreover, because an additional data collection and labeling operation is not needed, the temporal and economical costs may be reduced.

Moreover, in a conventional multiclass classification apparatus, because performance for a minority class is low, it is difficult to use pieces of data of a corresponding class, but according to the embodiments of the present invention, the data may be effectively used and thus may be applied to applications associated with several minority classes.

Moreover, according to the embodiments of the present invention, in clothing-related data where the use of data is limited because the degree of unbalance between classed is large, a clothing category classifier may be effectively learned and used through learning.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A multiclass classification apparatus robust to imbalanced data, the multiclass classification apparatus comprising:
a balanced learning data configuration unit configured to receive imbalanced learning data to obtain balanced learning data; and
a model learning unit configured to receive the balanced learning data from the balanced learning data configuration unit to provide a class result predicted through model learning.

2. The multiclass classification apparatus of claim 1, wherein the balanced learning data configuration unit comprises:
a feature extraction unit configured to extract a feature of the imbalanced learning data;
a feature dictionary unit configured to randomly sample some of feature maps obtained from the feature extraction unit to generate a feature dictionary; and
a feature generating unit configured to generate artificial data, based on a convex combination of a convex weight and the feature dictionary.

3. The multiclass classification apparatus of claim 2, wherein the feature generating unit comprises:
a generator configured to receive noise and a fake class; and
a convex weighting unit configured to output the convex weight by using softmax.

4. The multiclass classification apparatus of claim 3, wherein the feature generating unit complements a minority class with the artificial data.

5. The multiclass classification apparatus of claim 1, wherein the feature generating unit performs adversarial training which allows artificial data to be similar to a distribution of real data.

6. The multiclass classification apparatus of claim 2, wherein the feature extraction unit comprises:
a feature extractor configured to extract the feature; and
a feature adaptation unit configured to allow the feature to obtain one characteristic of a shape, an edge, and a color of an image, and
the obtained features are integrated as one.

7. The multiclass classification apparatus of claim 1, wherein the model learning unit comprises:
a tuning feature extraction unit configured to finely tune a feature extraction method of the feature extraction unit, based on the balanced learning data; and
a multiclass classification unit configured to classify a class into a plurality of classes by using the feature extracted from the tuning feature extraction unit.

8. A multiclass classification method robust to imbalanced data, the multiclass classification method comprising:
a balanced learning data configuration step of receiving imbalanced learning data to obtain balanced learning data by using a balanced learning data configuration unit; and
a model learning step of receiving the balanced learning data from the balanced learning data configuration unit to provide a class result predicted through model learning by using a model learning unit.

9. The multiclass classification method of claim 8, wherein the balanced learning data configuration step comprises:
a feature extraction step of extracting a feature of the imbalanced learning data by using a feature extraction unit;
a feature dictionary generating step of randomly sampling some of feature maps obtained from the feature extraction unit to generate a feature dictionary by using a feature dictionary unit; and
a feature generating step of generating artificial data by using a feature generating unit, based on a convex combination of a convex weight and the feature dictionary.

10. The multiclass classification method of claim 9, wherein the feature generating step comprises:
a generating step of receiving noise and a fake class by using a generator; and
a convex weighting unit configured to output the convex weight by using a convex weighting unit, based on softmax.

11. The multiclass classification method of claim 10, wherein the feature generating step comprises a step of complementing a minority class with the artificial data.

12. The multiclass classification method of claim 8, wherein the feature generating step comprises a step of performing adversarial training which allows artificial data to be similar to a distribution of real data.

13. The multiclass classification method of claim 9, wherein the feature extraction step comprises:
a feature extraction step of extracting the feature by using a feature extractor; and
a feature adaptation step of allowing the feature to obtain one characteristic of a shape, an edge, and a color of an image by using a feature adaptation unit, and
the obtained features are integrated as one.

14. The multiclass classification method of claim 8, wherein the model learning step comprises:
a tuning feature extraction step of finely tuning a feature extraction method of the feature extraction unit by using a tuning feature extraction unit, based on the balanced learning data; and
a multiclass classification step of classifying a class into a plurality of classes by using a multiclass classification unit, based on the feature extracted from the tuning feature extraction unit.

15. A feature generator used in a multiclass classification apparatus robust to imbalanced data, the feature generator comprising:
a generator configured to receive noise and a fake class;
a convex weighting unit configured to output a convex weight by using softmax;
an artificial data generating unit configured to generate artificial data, based on a convex combination of the convex weight output from the convex weighting unit and a previously generated feature dictionary; and
an adversarial training unit configured to perform adversarial training which allows the artificial data to be similar to a distribution of real data.
